(19) United States
(12) Patent Application Publication
(10) Pub. No.: US 2012/0189257 A1
(43) Pub. Date: Jul. 26, 2012

(54) OPTICAL FIBER, OPTICAL FIBER RIBBON AND OPTICAL FIBER CABLE

(75) Inventors: Minoru KASAHARA, Tokyo (JP); Minoru Saito, Tokyo (JP); Yasuo Nakajima, Tokyo (JP); Hiroki Tanaka, Tokyo (JP)

(73) Assignee: FURUKAWA ELECTRIC CO., LTD., Tokyo (JP)

(21) Appl. No.: 13/397,397

(22) Filed: Feb. 15, 2012

Related U.S. Application Data
(63) Continuation of application No. PCT/JP11/61047, filed on May 13, 2011.

(30) Foreign Application Priority Data
Jul. 22, 2010 (JP) 2010-165041

(51) Int. Cl. G02B 6/44; G02B 6/02

(52) U.S. Cl. 385/114; 385/123

(57) ABSTRACT

According to the present invention, there is provided an optical fiber, an optical fiber ribbon and an optical fiber cable that reduce both the increase in transmission loss and the decrease in strength. According to an embodiment of the present invention, there is provided an optical fiber in which an outer circumferential surface of an optical fiber is coated with a primary coating layer. In the optical fiber, the primary coating layer includes a ultraviolet curable resin, and the ultraviolet curable resin contains 0.05 or more and 0.75 or less parts by weight of a reactive silane coupling agent and 0.05 or more and 0.75 or less parts by weight of an unreactive silane coupling agent.

### CROSS-REFERENCES TO RELATED APPLICATIONS

This application is a continuation application of International Application No. PCT/JP2011/061047, filed May 13, 2011, which claims the benefit of Japanese Patent Application No. 2010-165041, filed Jul. 22, 2010. The contents of the aforementioned applications are incorporated herein by reference in their entities.

### TECHNICAL FIELD

The present invention relates to an optical fiber that is housed in a slot such as a slot rod and that is suitable for forming an optical fiber cable, and to an optical fiber ribbon and an optical fiber cable using the optical fiber.

### BACKGROUND ART

An optical fiber has a structure in which an optical fiber glass is coated with resin or the like, and it has a high rupture strength immediately after being produced. In general, an optical fiber is used in which a soft primary coating layer and a hard secondary coating layer are on a glass fiber or a plastic fiber including a core and a cladding and whose outer diameter is 250 μm.

The optical fiber is required to have the property of maintaining an initial high rupture strength when the optical fiber is used under various usage conditions for a long period of time. In particular, under an environment where an optical fiber is actually installed, the optical fiber is required to have durability for maintaining an optical transmission property and an initial dynamic strength for a long period of time. In particular, the optical fiber is highly required to have durability under a hot water atmosphere and durability under a high temperature and humidity atmosphere.

An optical fiber cable in which the number of fiber ribbons housed is more than 1000 is installed and used; as the number of subscribers using lines is increased, it is necessary to install further optical fiber cables. It is expected that a conduit for installing the optical fiber cable will reach a limit, and thus it is necessary to reduce the diameter of the optical fiber cable and increase its density.

In a slot type optical fiber cable, a plurality of optical fiber ribbons (hereinafter referred to as fiber ribbons for short) is housed in a stacked state within a plurality of helical slot grooves (slot) formed on the outer circumferential surface of a slot rod. The slot rod is a long body that is formed of plastic such as polyethylene; in the center thereof, a tension member formed with metal stranded wire, a fiberglass reinforced plastic (FRP) rod and the like. On the circumference of the slot rod, a tape wound layer that is formed by winding a tape such as a polyester tape is provided, and its surface is coated with a sheath layer made of polyethylene or the like.

In the fiber ribbon, a plurality of optical fibers is arranged parallel to each other, and they are coated with a ribbon coating layer formed of ultraviolet curable resin or the like. In the optical fiber cable, in order for the number of fiber ribbons that can be housed in the slot rod to be increased, the thickness of the ribbon coating layer of the fiber ribbon is reduced. When the diameter of the optical fiber cable is decreased, the slot needs to be reduced in depth and width.

When the optical fiber cable having a small diameter is bent, the fiber ribbon has difficulty in freely moving within the slot and is locally fixed. Hence, a portion of the optical fiber cable that receives a compression force in the longitudinal direction is buckled, and the fiber ribbon and the optical fiber are complicatedly bent. Furthermore, when the optical fiber cable is compressed at a low temperature, a lateral pressure from a slot wall surface is increased, and the optical fiber located at an end portion of the fiber ribbon is compressed in the longitudinal direction. Hence, when the optical fiber is made of glass, the fiber is buckled, microbending occurs and the transmission loss is increased. Furthermore, disadvantageously, glass fiber protrudes to remove the coating, and thus the fiber strength is reduced. In particular, when eight or more optical fibers constitute the fiber ribbon and its width is wide, such a problem tends to be produced.

[Patent document 1] Japanese Unexamined Patent Application Publication No. 2009-122209
[Patent document 2] Japanese Unexamined Patent Application Publication No. 2006-215445
[Patent document 3] Japanese Unexamined Patent Application Publication No. 2006-249264

### SUMMARY OF INVENTION

Patent document 1 discloses that, even when an optical fiber cable having a small diameter and a high density is bent, in order for the transmission loss to be prevented from being increased, a stress relief starting time when an pullout force of 0.3 N/mm is applied between the glass fiber of optical fibers constituting a fiber ribbon and a coating is decreased to fall within 1.5 minutes. Patent document 2 discloses that, in order for the strength of an optical fiber to be prevented from being reduced, the ultraviolet curable resin of the primary coating layer of an optical fiber contains 0.1 or more and 3.0 or less parts by weight of a low-molecular-weight (unreactive) silane coupling agent. Patent document 3 discloses that a liquid curable resin composition having a high fiber strength is provided, and that it contains 0.1 to 10 percent by mass of an alkoxysilane compound having no radical polymerizing functional group and 0.01 to 1 percent by mass of a hindered amine compound.

However, all the patent documents described above do not teach an optical fiber that reduces both the increase in transmission loss and the decrease in strength while ensuring reliability for long-term use. As described later, when a relatively large amount of unreactive silane coupling agent is included in an optical fiber, after an optical fiber cable is completed, the increase in transmission loss caused by the bending of the optical fiber cable is disadvantageously increased.

An object of the present invention is to provide an optical fiber, a fiber ribbon and an optical fiber cable that reduce both the increase in transmission loss and the decrease in strength while ensuring reliability for long-term use.

There is provided an optical fiber in which an outer circumferential surface of an optical fiber is coated with a primary coating layer. In the optical fiber, the primary coating layer includes a resin, and the resin contains 0.05 or more and 0.75 or less parts by weight of a reactive silane coupling agent and 0.05 or more and 0.75 or less parts by weight of an unreactive silane coupling agent.

In the optical fiber of the present invention, reliability for long-term use is ensured, and, even when the optical fiber, a fiber ribbon and an optical fiber cable in which their diameter is reduced and their density is increased are bent, it is possible to reduce both the increase in transmission loss and the decrease in strength.

### BRIEF DESCRIPTION OF THE DRAWINGS

FIG. 1A is a schematic cross-sectional view showing a multi (400-core) fiber cable according to an embodiment of the present invention;

FIG. 1B is a schematic cross-sectional view showing a multi (1000-core) fiber cable according to the embodiment of the present invention;

FIG. 2 is a schematic cross-sectional view showing a fiber ribbon according to the embodiment of the present invention;

FIG. 3 is a schematic cross-sectional view showing an optical fiber according to the embodiment of the present invention;

FIG. 4A is a schematic diagram of an pullout test sample according to the embodiment of the present invention;

FIG. 4B is a schematic diagram of the pullout test sample according to the embodiment of the present invention;

FIG. 5 is a graph showing an example of the increase in transmission loss in a heat cycle test for an optical fiber cable; and

FIG. 6 is a diagram obtained by plotting the maximum values of increases in transmission loss and the values of retention rates of 15% failure probability after ZSA (zero stress aging) when the amount of reactive silane coupling agent added is fixed, and the amount of unreactive silane coupling agent added is changed (the unreactive silane coupling agent is fixed to 0.3 parts by weight).

### DESCRIPTION OF EMBODIMENTS

An embodiment of the present invention will be described in detail below with reference to accompanying drawings. In the drawings, which will be described below, parts having the same functions are identified with common reference numerals, and their description will not be repeated.

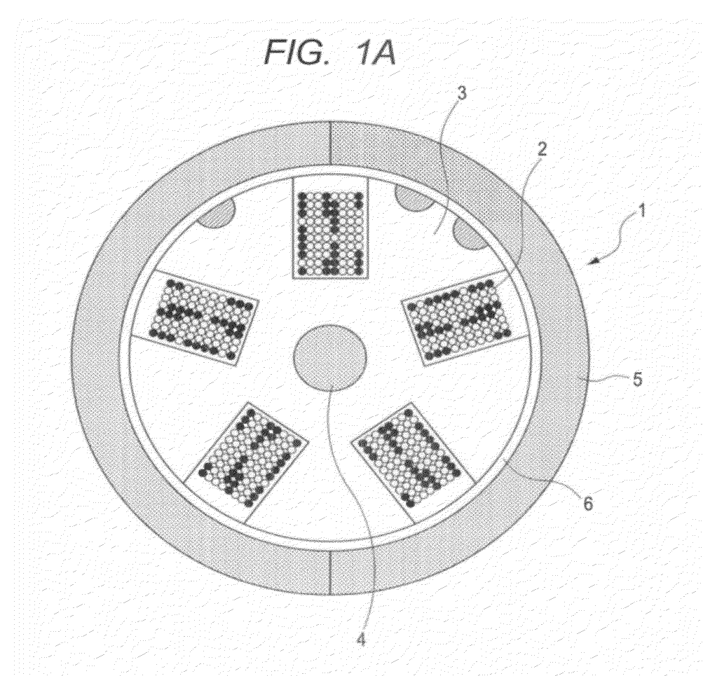

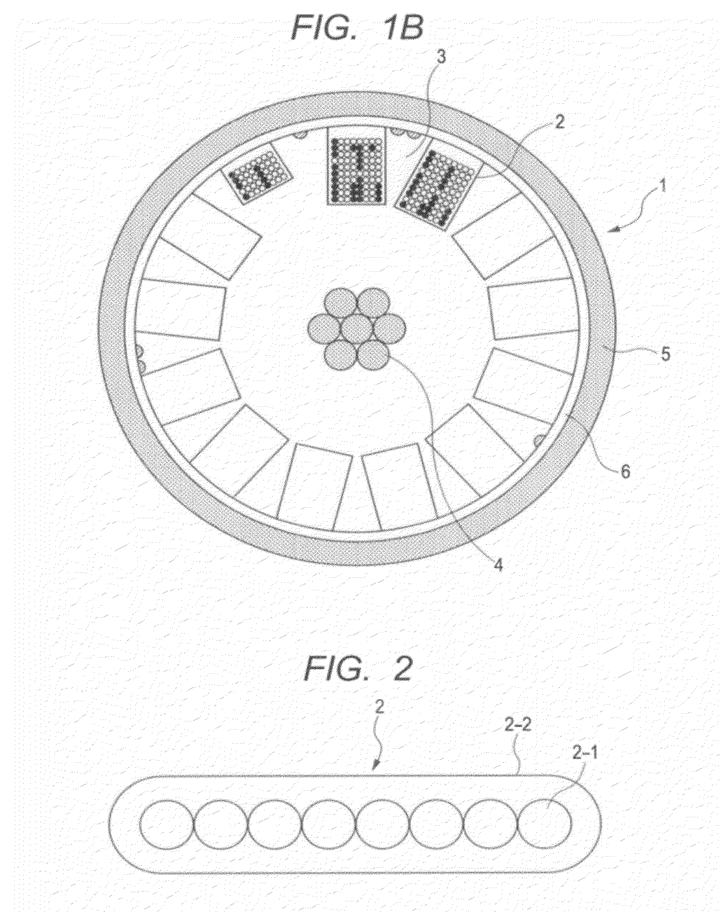

FIGS. 1A and 1B show schematic cross-sectional views of a multi fiber cable 1 according to the embodiment of the present invention. The multi fiber cable 1 includes: a plurality of fiber ribbons 2 that is arranged within a slot; a slot rod 3 that has a plurality of slot grooves (slot) holding a plurality of fiber ribbons 2; a tension member 4 in the center of the slot rod 3; a sheath layer 5; and a retaining tape wound layer 6.

FIG. 2 shows a schematic cross-sectional view of the fiber ribbon 2 according to the embodiment of the present invention. The fiber ribbon 2 includes a plurality of optical fibers 2-1 (in this example, eight ribbons) and a ribbon coating layer 2-2.

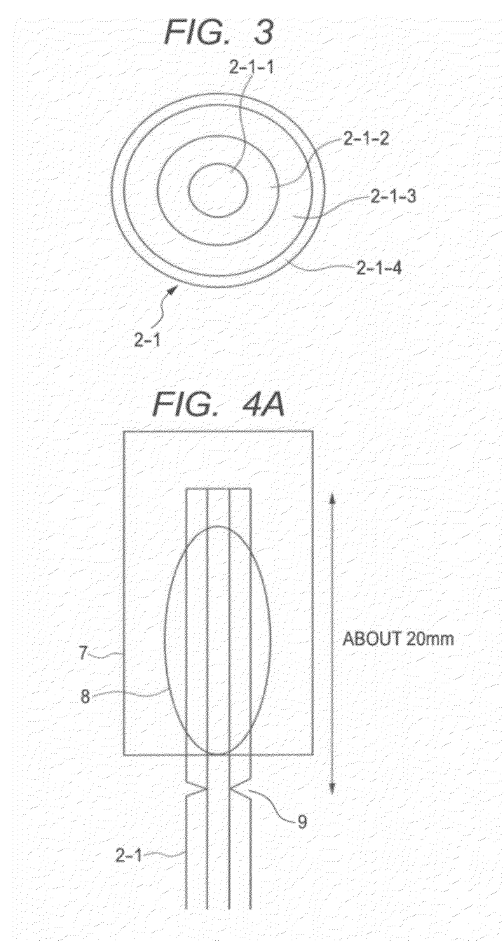

FIG. 3 shows a schematic cross-sectional view of the optical fiber according to the embodiment of the present invention. In this example, an optical fiber glass 2-1-1 having a diameter of 125 μm is coated with a primary soft coating layer 2-1-2 and is further coated with a secondary hard coating layer 2-1-3.

The optical fiber according to the embodiment of the present invention may be either for single-mode transmission or for multi-mode transmission. The materials of the core and the cladding of the optical fiber are not limited; for example, materials such as quartz that are conventionally used can be used. In the optical fiber of the present embodiment, any of the materials used in normal optical fibers such as a glass optical fiber and a plastic optical fiber may be used.

The primary soft coating layer 2-1-2 of the present embodiment contains: a polyether urethane acrylate as an oligomer, and a monofunctional acrylate monomer whose functional group is changed to different type, a vinyl monomer and a photo initiator being added thereto to adjust the Young's modulus of a hardened film to 0.5 to 2.0 MPa; and an ultraviolet curable resin in which the amounts of reactive and unreactive silane coupling agents are changed to adjust adhesion with the glass fiber. In other words, in the present embodiment, the ultraviolet curable resin contained in the primary soft coating layer includes both the reactive silane coupling agent and the unreactive silane coupling agent.

The reactive silane coupling agent is a silane coupling agent that is incorporated into the cross-linked structure contained in the primary soft coating layer; examples thereof include γ-mercaptopropyltrimethoxysilane and γ-methacryloxypropyltrimethoxysilane; the silane coupling agent is not limited to these examples. The unreactive silane coupling agent is a silane coupling agent that does not contain a radical polymerizing functional group; examples thereof include diethoxydimethylsilane. Here, the term “reactive” refers to the term “radical polymerizing”; the term “reactive” is not limited to this term.

The secondary hard coating layer 2-1-3 contains an ultraviolet curable resin in which the Young's modulus of a hardened film is 550 to 850 MPa. Although there is no limitation in the present embodiment, the outer diameter of the primary coating is 185 to 195 μm, and the outer diameter of the secondary coating is about 245 μm.

The Young's modulus of the coating layer of the optical fiber that is actually produced is affected by production conditions. Hence, the Young's modulus is not measured by producing a sheet (a film that is obtained by UV-curing resin in a sheet state), but measured from the optical fiber that is actually produced.

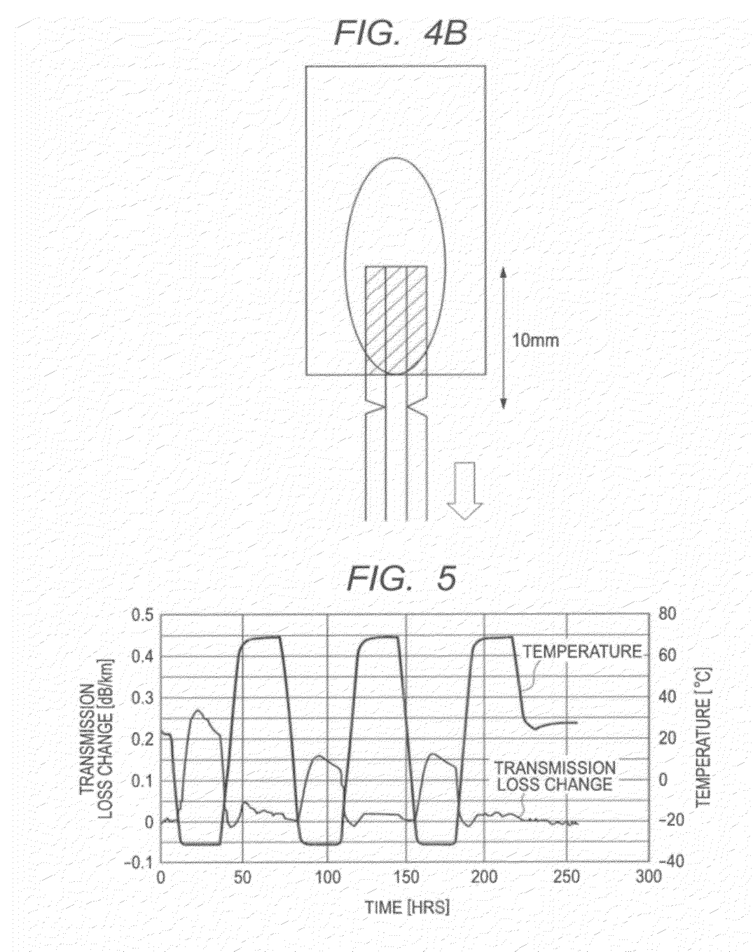

For the measurement of an pullout force, for example, an optical fiber is prepared that is obtained by cutting the optical fiber 2-1 into a length of about 200 mm. As shown in FIG. 4A, the coating is notched in a position about 20 mm away from its end portion, a nick 9 is formed and the glass fiber of the nick 9 is exposed. As shown in FIG. 4A, a part of the 20 mm end portion of the optical fiber is adhered and fixed with an adhesive 8 to an end portion of a mat 7 obtained by cutting sandpaper into a rectangle. Here, the adhesive 8 and the nick 9 are separated such a space that the adhesive 8 does not cover the nick 9. As the adhesive 8, an adhesive that is not easily deformed when hardened, for example, “Aron Alpha” in the form of jelly (registered trademark) (made by Toagosei Co. Ltd.) is used.

Then, as shown in FIG. 4B, the adhesive 8 and the optical fiber 2-1 are cut in a position 10 mm away from the coating nick 9. The mat 7 and an end of the optical fiber 2-1 that is not adhered to the mat 7 are chucked with a tensile tester. The distance of the chucking between the coating nick 9 and the optical fiber 2-1 is 100 mm. While the portion where the mat 7 and the optical fiber 2-1 are adhered is fixed, the optical fiber 2-1 is pulled at an rate of force of 5 mm/min., and thus the glass fiber from the adhesion portion indicated by the oblique lines of FIG. 4B to the nick 9 is pulled and the maximum value of stress is sought. The results thereof are shown in Table 1. The value of the pullout force of Table 1 is an average value of results obtained by repeatedly performing the measurement six times.

For the measurement of dynamic strength, for example, an optical fiber is prepared that is obtained by cutting the optical fiber 2-1 into a length of about 2 m. Both ends of the optical fiber are wound and fixed around the mandrels (φ 100 mm) of the tensile tester, respectively. The distance between both the mandrels is 500 mm. The optical fiber 2-1 is pulled at a tensile rate of 2.5%/min., and the rupture strength is measured. After the optical fiber is left under ZSA at a temperature of 85° C. and a relative humidity of 85% for 30 days, the rupture strength is likewise measured. After the ZSA, the results of retention rates of 15% failure probability are shown in Table 1. Values of the ZSA in Table 1 are retention rates of 15% failure probability [%].

Four optical fibers that were obtained by applying a colored layer about 5 μm thick to the optical fibers of the present embodiment were arranged parallel to each other, and a coated four-core fiber ribbon having 320 μm thick and 1.1 mm wide was prepared. This four-core fiber ribbon was immersed in hot water of 60° C. for 200 days, and then the transmission loss of each core fiber ribbon was measured at a wavelength of 1.55 μm. The results thereof are shown in Table 1.

Eight optical fibers that were obtained by applying a colored layer about 5 μm thick to each of the optical fibers of the present embodiment were arranged parallel to each other, and an eight-core fiber ribbon of 320 μm thick and 2.1 mm wide was prepared by ribbon coating. With this eight-core fiber ribbon, a 400-core cable as shown in FIG. 1A was prepared in which its outer diameter was 14.6 mm and in which an S-type slot with five slot grooves having 600 mm helical groove pitches and a depth of 4.0 mm was used. The number of fiber ribbons stacked for each slot groove was 10.

Since this 400-core cable has a small diameter of the slot, a shallow depth of the groove and a space of 80 μm or less in a vertical direction, when the fiber ribbon cannot be moved in the longitudinal direction due to friction when the cable is bent, the fiber ribbon loosens inside the bending, makes contact with a wall surface beyond the movable range (window) and thus buckles, with the result that the optical fibers are compressed in the longitudinal direction and microbending occurs. Consequently, the transmission loss is more likely to be increased.

The 400-core cable of 1000 m long was wound around a drum having a body diameter of 1400 mm, then it was placed in a heat cycle tank and was subjected to a heat cycle test of −30° C. to 70° C. for three cycles and the transmission loss of each optical fiber within the 400-core cable was measured at a wavelength of 1.55 μm. An example of variations in transmission loss is shown in FIG. 5. In FIG. 5, a thick line represents variations in temperature, and a thin line represents variations in transmission loss.

Only optical fibers at both ends of the fiber ribbon at the deepest portion of each groove show the increase in transmission loss. As shown in the example of FIG. 5, the transmission loss increases on the side of low temperatures and on the side of high temperatures. The transmission loss is the largest at a temperature of −30° C. in the first cycle. In the subsequent cycles, the transmission loss increased relatively slightly. The maximum values of increases in the transmission loss of the optical fiber were obtained, and the results thereof are shown in Table 1.

TABLE 1

| | Example | Example | Example | Example | Example | Example | Comparative | Comparative | Comparative | Comparative |
|---|---|---|---|---|---|---|---|---|---|---|
| | 1 | 2 | 3 | 4 | 5 | 6 | Example 1 | Example 2 | Example 3 | Example 4 |
| Unreactivity | 0.05 | 0.05 | 0.1 | 0.5 | 0.75 | 0.75 | 0 | 0.1 | 0.5 | 1 |
| Reactivity | 0.3 | 0.75 | 0.3 | 0.3 | 0.05 | 0.3 | 0.3 | 0 | 1 | 0.3 |
| Pullout force | 5 | 7 | 6 | 10 | 9 | 12 | 4 | 4 | 13 | 13 |
| Transmission | 0.04 | 0.06 | 0.05 | 0.07 | 0.06 | 0.1 | 0.03 | 0.02 | 0.14 | 0.14 |
| loss | | | | | | | | | | |
| ZSA | 90 | 90 | 92 | 96 | 98 | 98 | 80 | 92 | 96 | 100 |
| 60° C. Hot | 0.01 | 0.01 | 0.01 | 0.01 | 0.01 | 0.01 | 0.01 | 0.40 | 0.01 | 0.01 |
| water | | | | | | | | | | |
| Determination | I | I | I | I | I | II | III | III | III | III |

*Unreactivity: the amount of unreactive silane coupling agent added [parts by weight]
*Reactivity: the amount of reactive silane coupling agent added [parts by weight]
*Pullout force: pullout force [N]
*Transmission loss: the maximum values of increases in transmission loss [dB/km] were measured at a wavelength of 1.55 μm
*ZSA: retention rate of 15% failure probability after ZSA [%]
*60° C. hot water: the transmission loss values [dB/km] after immersion in 60° C. hot water for 200 days were measured at a wavelength of 1.55 μm *Determination: evaluation was performed on a scale of three steps below. I represents “sufficiently and practicably durable”; II represents “practicably durable”; and III represents “practicably undurable”.

As a person skilled in the art related to the present invention understands, in the long-term reliability of the use of optical fibers, the maximum values of increases in transmission loss and the transmission loss values after immersion in 60° C. hot water for 200 days indicate one kind of indicator for evaluating the increase in the transmission loss of optical fibers, and the pullout force indicating adhesion between the glass fiber of the optical fiber and the coating can also be said to be one kind of indicator for transmission loss. The values of retention rates of 15% failure probability after ZSA indicate one kind of indicator for evaluating the decrease in the strength of optical fibers.

As a person skilled in the art related to the present invention understands, in terms of the increase in the transmission loss of optical fibers, the value of the pullout force [N] is preferably about 5 to 12 for practical use. The maximum value of the increase in transmission loss [dB/km] (at a measurement wavelength of 1.55 μm) is preferably 0.1 or less for practical use. The retention rate of 15% failure probability [%] after ZSA is preferably 90 or more for practical use. The transmission loss value [dB/km] after immersion in 60° C. hot water (at a measurement wavelength of 1.55 μm) is preferably 0.1 or less for practical use.

Since, in Comparative Example 1, the amount of unreactive silane coupling agent added is zero, and the value of ZSA is 80, which is relatively low, Comparative Example 1 is not preferable for practical use. Since, in Comparative Example 2, the amount of reactive silane coupling agent added is zero, and the value of 60° C. hot water is 0.4, which is relatively high, Comparative Example 2 is not preferable for practical use. Since, in Comparative Example 3, the amount of reactive silane coupling agent added is one, and the maximum value of the increase in transmission loss is 0.14, which is relatively high, Comparative Example 3 is not preferable for practical use. Since, in Comparative Example 4, the amount of unreactive silane coupling agent added is one, and the maximum value of the increase in transmission loss is 0.14, which is relatively high, Comparative Example 4 is not preferable for practical use.

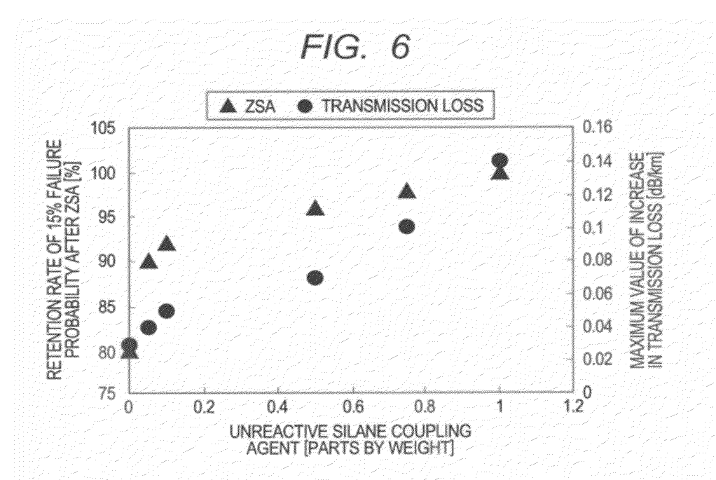

FIG. 6 is a diagram that is obtained by plotting the maximum values of increases in transmission loss and the values of retention rates of 15% failure probability after ZSA when, based on the values in Table 1 in the present embodiment, the amount of reactive silane coupling agent added is 0.3 parts by weight, and the amount of unreactive silane coupling agent added is variously changed. FIG. 6 shows that, although, when the unreactive silane coupling agent is not added, the maximum value of the increase in transmission loss is 0.03, which is low, the value of retention rate of 15% failure probability after ZSA is 80, which is also low, and it is therefore impossible to reduce both the increase in transmission loss and the decrease in strength. When the amount of unreactive silane coupling agent added is increased, the maximum value of the increase in transmission loss is increased, and the value of retention rate of 15% failure probability after ZSA tends to be also increased. Hence, it is impossible to reduce both the increase in transmission loss and the decrease in strength by changing only the amount of unreactive silane coupling agent added.

As shown in Table 1, unless the amount of unreactive silane coupling agent added and the amount of reactive silane coupling agent added are not optimum, it is impossible to reduce both the increase in the maximum value of the increase in transmission loss and the decrease in strength. In other words, the amounts of unreactive silane coupling agent and reactive silane coupling agent contained in the primary coating layer coating the optical fiber glass according to the present invention are optimized, and thus it is possible to reduce both the increase in the transmission loss of and the decrease in the strength of the optical fiber.

As shown in Table 1, in the optical fibers (Examples 1 to 6) in which the amount of unreactive silane coupling agent added is 0.05 parts by weight or more and 0.75 parts by weight or less and the pullout force is 5N or more and 12N or less, the maximum value of the increase in transmission loss is 0.1 dB/km or less. Hence, embodiments in which the amount of unreactive silane coupling agent added is 0.05 parts by weight or more and 0.75 parts by weight or less are preferable for practical use.

In the optical fibers of Examples 1 to 4 in which the amount of unreactive silane coupling agent added is 0.05 parts by weight or less, the maximum value of the increase in transmission loss is 0.07 dB/km or less. Hence, more preferably, the amount of unreactive silane coupling agent added is 0.05 parts by weight or more and 0.5 parts by weight or less.

Since, in the optical fibers (Examples 1 to 6) of the present embodiment, the retention rate of 15% failure probability after ZSA is 90% or more, which is sufficiently high, the optical fibers are sufficiently durable for practical use in terms of reliability in the long-term use of optical fibers.

Even when 0.05 to 0.75 parts by weight of the unreactive silane coupling agent is contained, in the optical fiber (Comparative Example 2) in which less than 0.05 parts by weight of the reactive silane coupling agent is contained and the pullout force is less than 5N, the transmission loss value after immersion in 60° C. hot water for 200 days is 0.4, which is significantly high. As seen from Table 1, when the amount of unreactive silane coupling agent added is 0.05 parts by weight or more, it is possible to reduce the increase in the transmission loss after immersion in 60° C. hot water for 200 days.

Even when 0.05 to 0.75 parts by weight of the unreactive silane coupling agent is contained, in the optical fiber (Comparative Example 3) in which the amount of reactive silane coupling agent added is 0.75 parts by weight or more and the pullout force is more than 12N, the maximum value of the increase in transmission loss is 0.14, which is significantly high. Hence, by adding 0.75 parts by weight or less of the unreactive silane coupling agent, it is possible to reduce the increase in transmission loss. Therefore, the embodiments in which the amount of unreactive silane coupling agent added is 0.05 parts by weight or more and 0.75 parts by weight or less are preferable for practical use.

The present invention is not limited to the 400-core optical fiber cable of the present embodiment; the present invention can be applied to the 1000-core optical fiber cable shown in FIG. 1B and to a multi fiber cable in which its diameter is reduced and its density is increased and which has more than 1000 core fiber ribbons.

1. An optical fiber in which an outer circumferential surface of an optical fiber is coated with a primary coating layer,
wherein the primary coating layer includes a resin, and
the resin contains 0.05 or more and 0.75 or less parts by weight of a reactive silane coupling agent and 0.05 or more and 0.75 or less parts by weight of an unreactive silane coupling agent.

2. The optical fiber according to claim 1,
wherein a stress produced by applying an pullout force of 50%/minute between the optical fiber and the primary coating layer is not less than 5N and not more than 12N.

3. The optical fiber according to claim 1,
wherein the resin includes 0.05 or more and 0.5 or less parts by weight of the unreactive silane coupling agent.

4. An optical fiber ribbon comprising:
a plurality of the optical fibers according to claim 1,
wherein each of the plurality of the optical fibers is further coated with a secondary coating layer and a colored layer, and
the plurality of the optical fibers is arranged parallel to each other and is coated with a ribbon coating layer.

5. An optical fiber cable comprising:
the optical fiber ribbon according to claim 4; and
a slot which houses a plurality of the optical fiber ribbons in a stacked manner.
